(19) United States
(12) Patent Application Publication
(10) Pub. No.: US 2025/0350057 A1
(43) Pub. Date: Nov. 13, 2025

(54) WIRE HARNESS

(71) Applicant: YAZAKI CORPORATION, Tokyo (JP)

(72) Inventors: Toshiharu Takahashi, Makinohara-shi (JP); Takashi Matsunaga, Makinohara-shi (JP); Keigo Tsubo, Makinohara-shi (JP); Masayoshi Takayanagi, Makinohara-shi (JP); Shingo Hamada, Tokyo (JP); Daiki Amemiya, Tokyo (JP); Kenji Kajikawa, Tokyo (JP)

(21) Appl. No.: 19/277,422

(22) Filed: Jul. 23, 2025

Related U.S. Application Data
(63) Continuation of application No. PCT/JP2024/002125, filed on Jan. 25, 2024.

(30) Foreign Application Priority Data
Feb. 27, 2023 (JP) 2023-027923

(51) Int. Cl. H01R 12/77

(52) U.S. Cl. CPC H01R 12/774; H01R 2201/26

(57) ABSTRACT

A wire harness includes a connector, a first flexible printed wiring board, and a second flexible printed wiring board, and in this configuration, the connector includes a plurality of terminals and housings, each of the terminals has a rod-shaped or tubular insertion portion, the housings retain the terminals arranged in a plurality of rows with the insertion portion protruding, the terminals includes a first terminal group and a second terminal group, the first flexible printed wiring board is provided with a through-hole into which the insertion portion of the first terminal group is inserted and a printed circuit connected to the insertion portion of the first terminal group, and the second flexible printed wiring board is provided with a through-hole into which the insertion portion of the second terminal group is inserted and a printed circuit connected to the insertion portion of the second terminal group.

### CROSS-REFERENCE TO RELATED APPLICATION

This application is a continuation application of International Application No. PCT/JP2024/002125 filed on Jan. 25, 2024 which claims the benefit of priority from Japanese Patent Application No. 2023-027923 filed on Feb. 27, 2023 and designating the U.S., the entire contents of which are incorporated herein by reference.

### BACKGROUND OF THE INVENTION

### 1. Field of the Invention

The present invention relates to a wire harness.

### 2. Description of the Related Art

Conventionally, a cable connection structure for a flexible cable has been known. JP 2021-036 502 A discloses a cable connection structure that includes a flexible cable, a housing, a cover, and an elastic member that is sandwiched together with the flexible cable by the cover and the housing, adhering closely to the flexible cable.

For a wire harness, it is desirable to achieve both multi-polarization of a connector and the suppression of size enlargement of the connector.

### SUMMARY OF THE INVENTION

The present invention is intended to provide a wire harness that achieves both multi-polarization of a connector and the suppression of size enlargement of the connector.

In order to achieve the above mentioned object, a wire harness according to one aspect of the present invention includes: a connector that includes a plurality of terminals and a housing, each of the terminals having a rod-shaped or tubular insertion portion, the housing retaining the terminals arranged in a plurality of rows with the insertion portion protruding, the arranged terminals including a first terminal group and a second terminal group; a first flexible printed wiring board provided with a through-hole into which the insertion portion of the first terminal group is inserted and a printed circuit connected to the insertion portion of the first terminal group; and a second flexible printed wiring board provided with a through-hole into which the insertion portion of the second terminal group is inserted and a printed circuit connected to the insertion portion of the second terminal group.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a wire harness and a mating connector in an embodiment;

FIG. 2 is a diagram illustrating the constituent components of the wire harness according to an embodiment;

FIG. 3 is a perspective view of an outer housing according to an embodiment;

FIG. 4 is a perspective view of an inner housing according to an embodiment;

FIG. 5 is a perspective view of a terminal according to an embodiment;

FIG. 6 is a perspective view of a first flexible printed wiring board according to an embodiment;

FIG. 7 is a perspective view illustrating a printed circuit of the first flexible printed wiring board according to an embodiment;

FIG. 8 is a perspective view of a second flexible printed wiring board according to an embodiment;

FIG. 9 is a perspective view illustrating a printed circuit of the second flexible printed wiring board according to an embodiment;

FIG. 10 is a perspective view of a cover according to an embodiment;

FIG. 11 is a diagram illustrating an operation of inserting the inner housing;

FIG. 12 is a diagram illustrating an operation of inserting the terminal;

FIG. 13 is a diagram illustrating an operation of installing the flexible printed wiring board;

FIG. 14 is a plan view of the installed flexible printed wiring board;

FIG. 15 is a diagram illustrating an operation of attaching the cover;

FIG. 16 is a diagram illustrating an operation of folding the wiring board;

FIG. 17 is a diagram illustrating an operation of retaining the wiring board;

FIG. 18 is a diagram illustrating an operation of assembling a lever;

FIG. 19 is a diagram of a wire harness according to a modification of an embodiment;

FIG. 20 is a diagram of a wire harness according to a modification of an embodiment;

FIG. 21 is a diagram of a wire harness according to a modification of an embodiment;

FIG. 22 is a diagram of a wire harness according to a modification of an embodiment; and

FIG. 23 is a diagram of a wire harness according to a modification of an embodiment.

### DETAILED DESCRIPTION OF THE PREFERRED EMBODIMENTS

A wire harness according to an embodiment of the present invention is now described in detail with reference to the drawings. Moreover, the present invention is not limited to embodiments described herein. Additionally, the components in the embodiments described below may include those readily conceivable by those skilled in the art or substantially identical ones.

### EMBODIMENTS

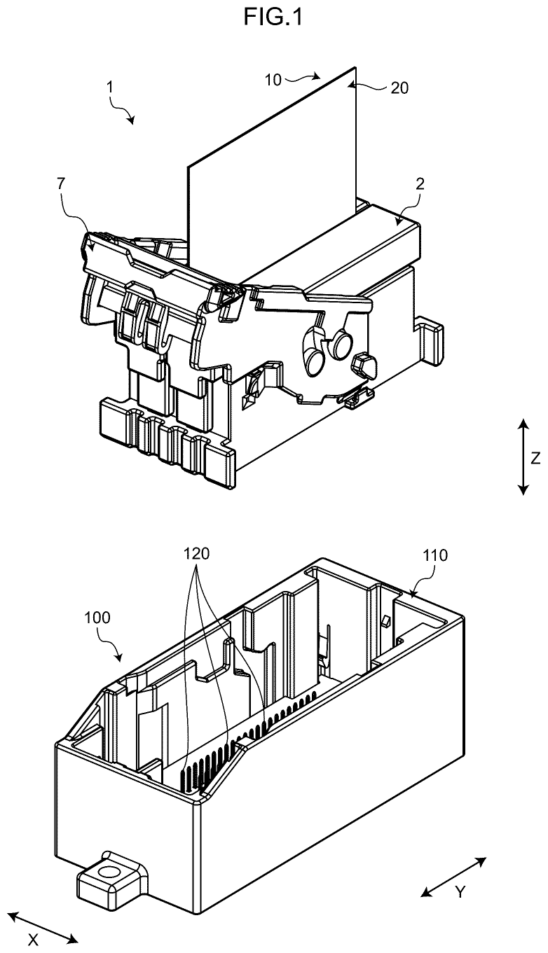

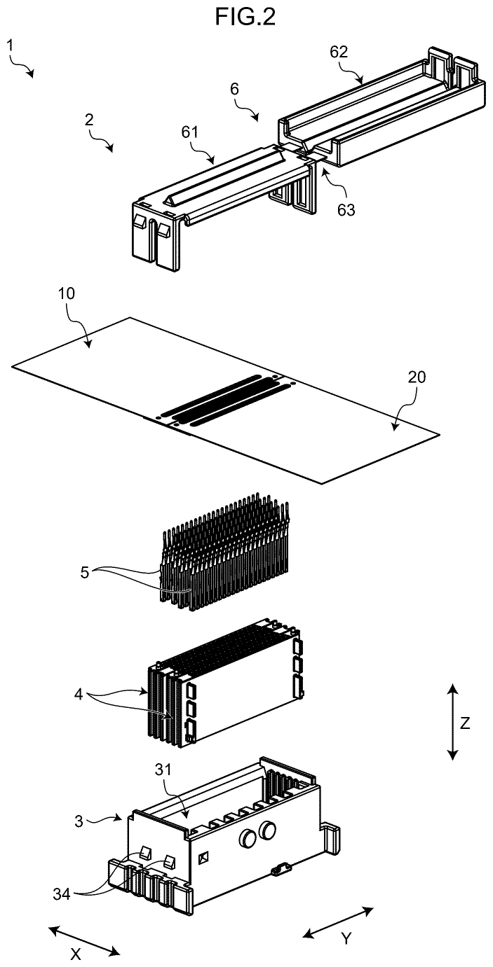

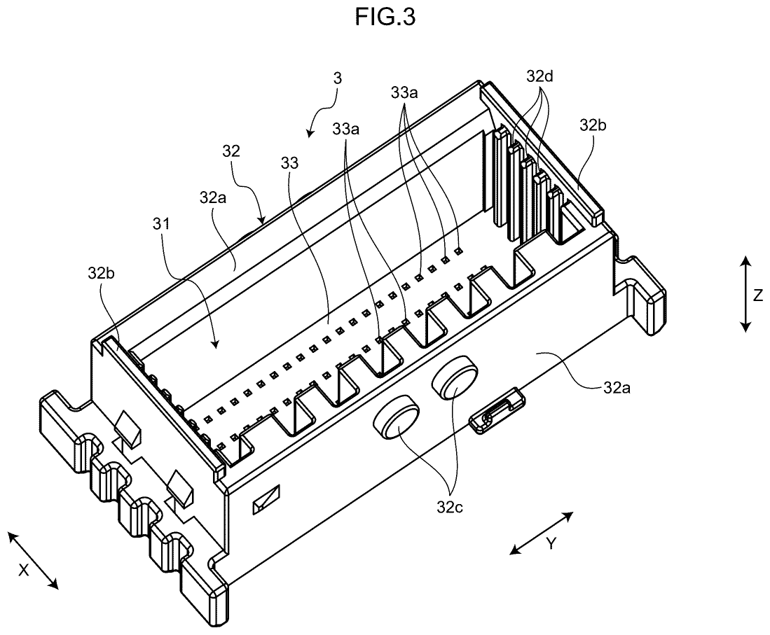

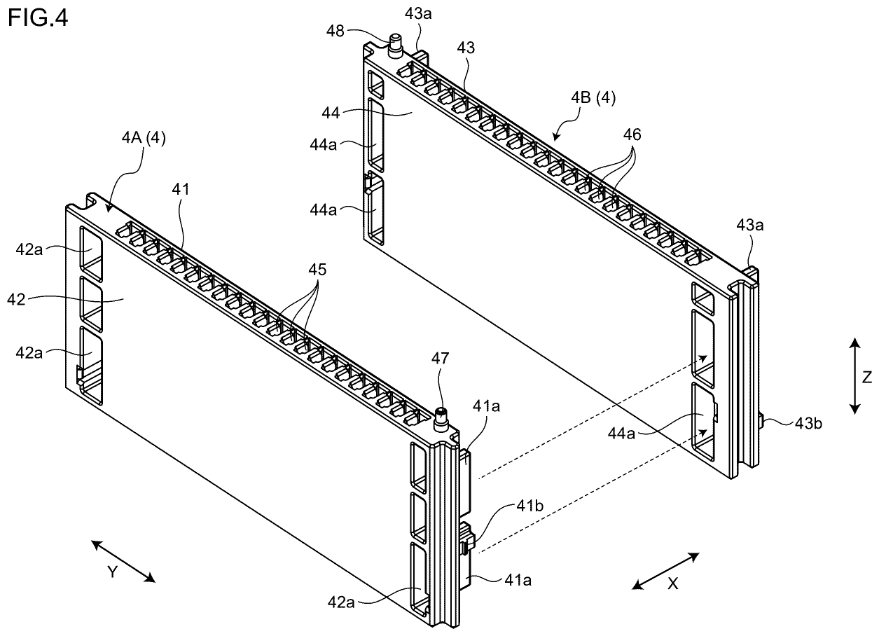

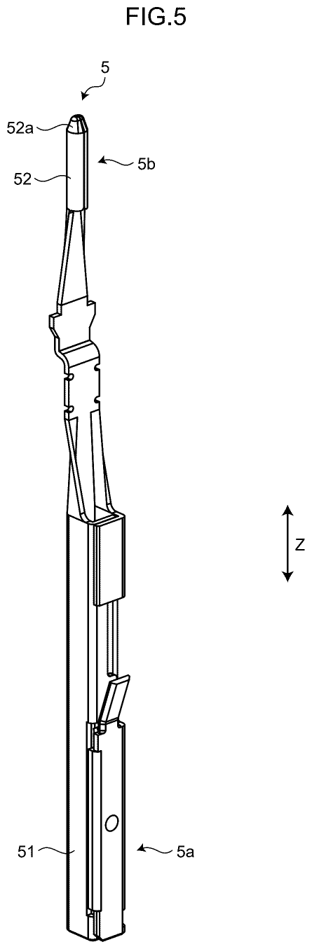

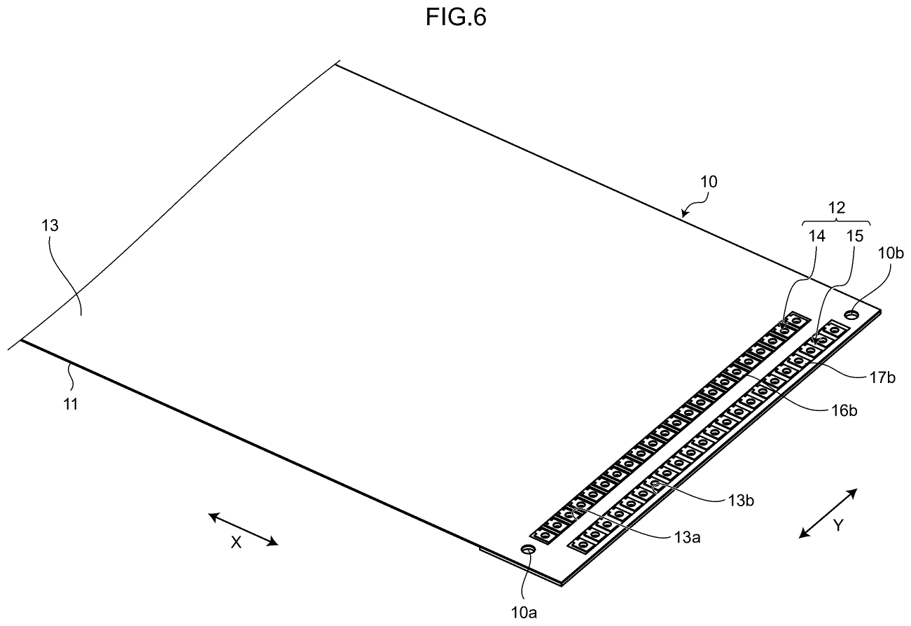

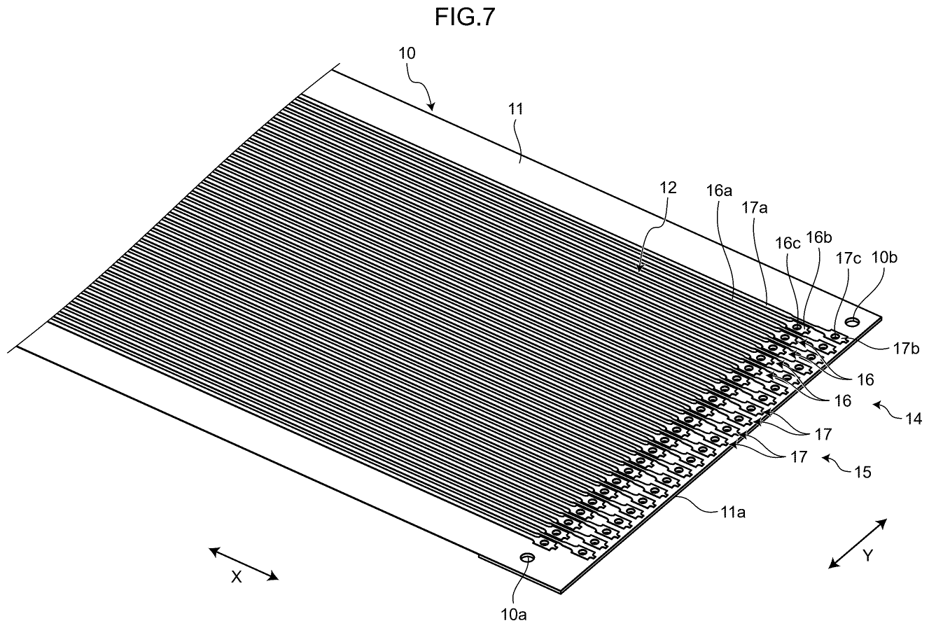

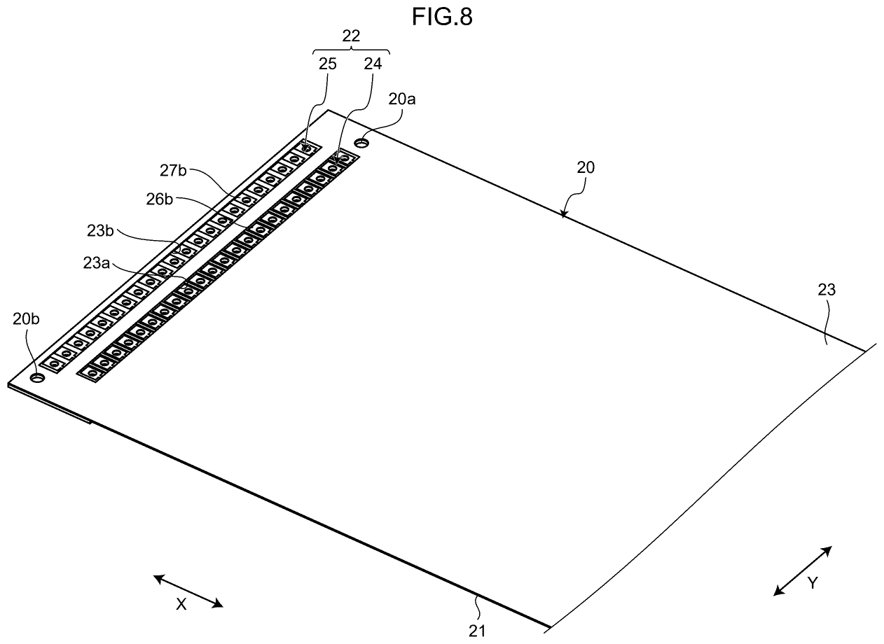

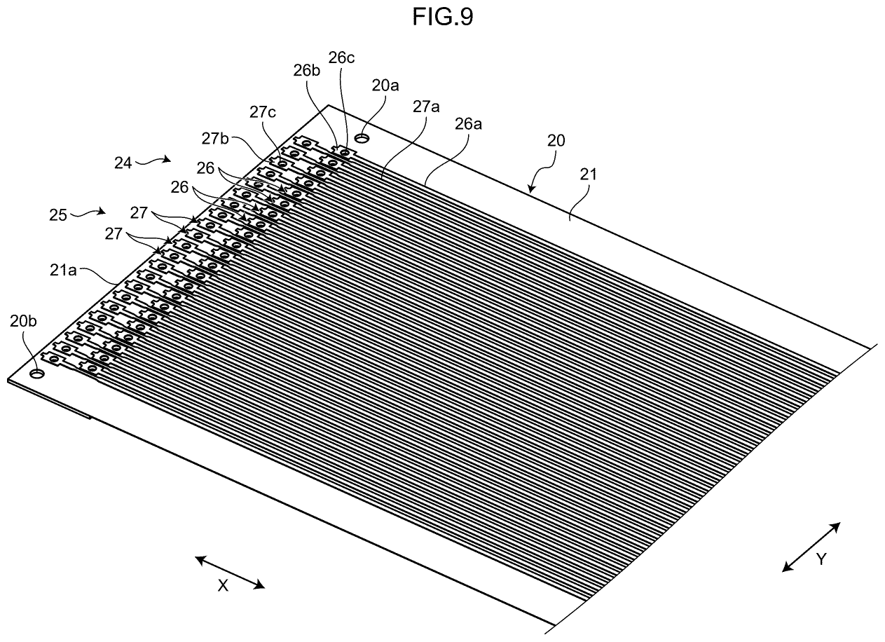

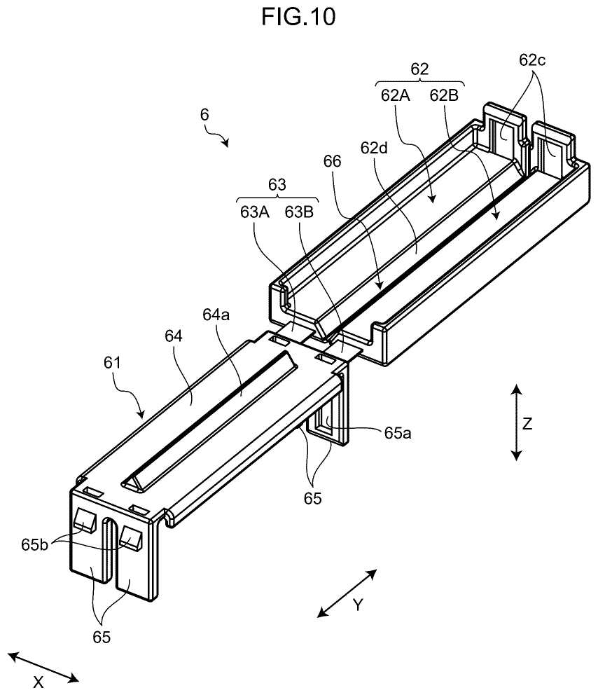

An embodiment is described with reference to FIGS. 1 to 18. The present embodiment relates to a wire harness. FIG. 1 is a perspective view illustrating a wire harness and a mating connector according to the present embodiment, FIG. 2 is a view illustrating the constituent components of the wire harness according to the present embodiment, FIG. 3 is a perspective view of an outer housing according to the present embodiment, FIG. 4 is a perspective view of an inner housing according to the present embodiment, FIG. 5 is a perspective view of a terminal according to the present embodiment, FIG. 6 is a perspective view of a first flexible printed wiring board according to the present embodiment, FIG. 7 is a perspective view illustrating a printed circuit of the first flexible printed wiring board according to the present embodiment, FIG. 8 is a perspective view of a second flexible printed wiring board according to the present embodiment, FIG. 9 is a perspective view illustrating a printed circuit of the second flexible printed wiring board according to the present embodiment, and FIG. 10 is a perspective view of a cover according to the present embodiment.

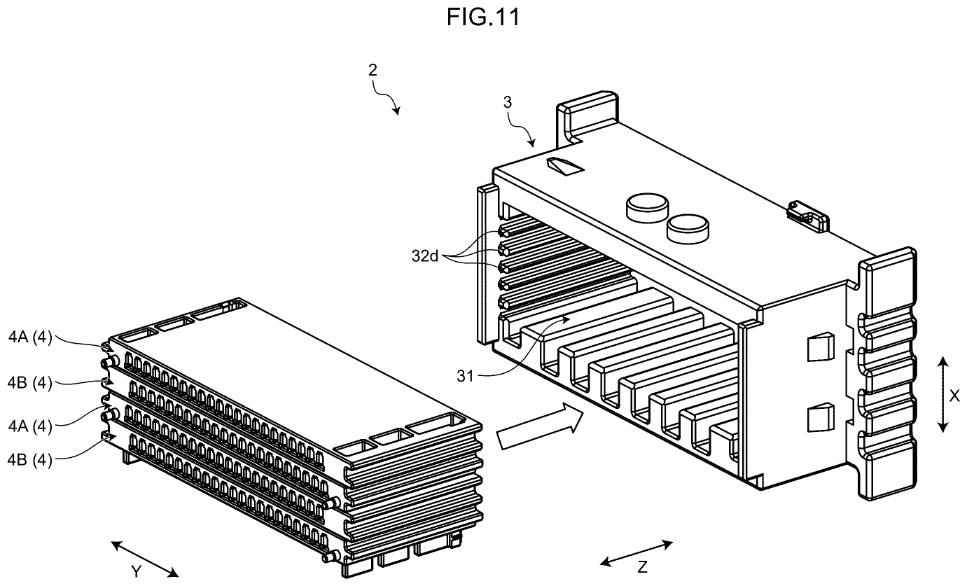

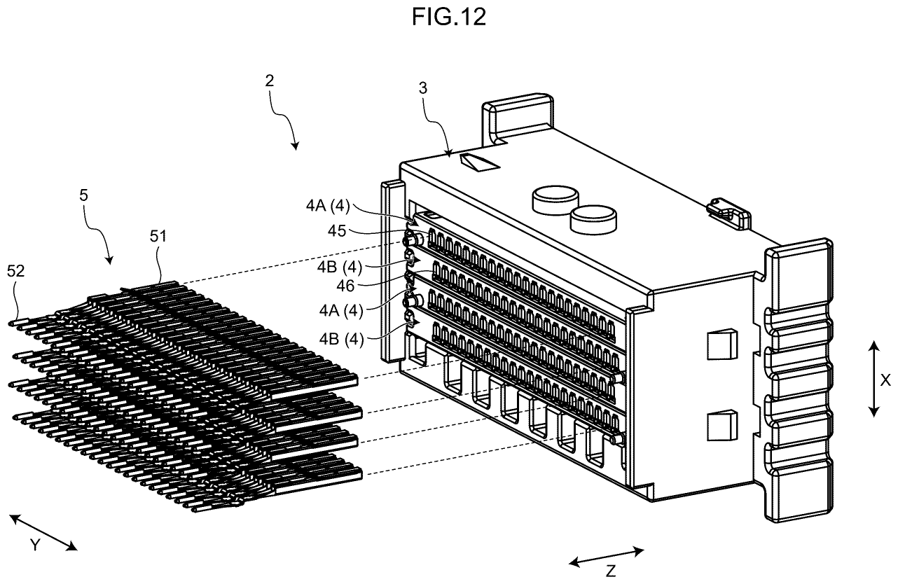

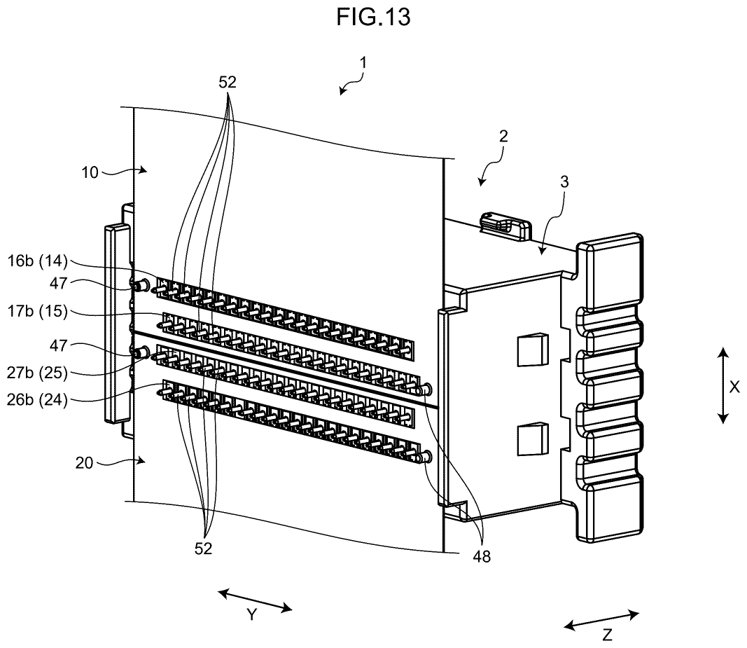

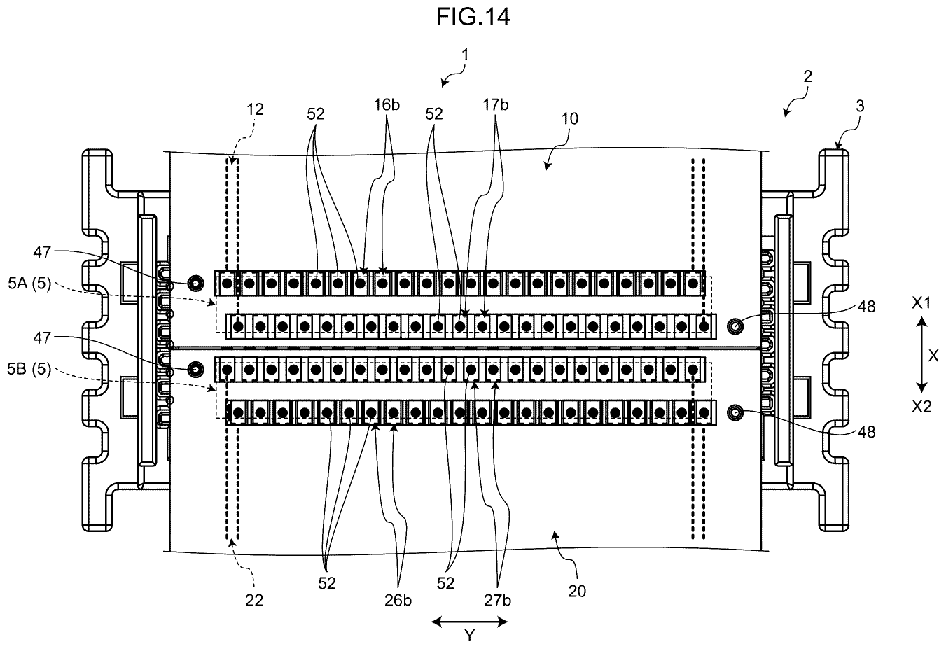

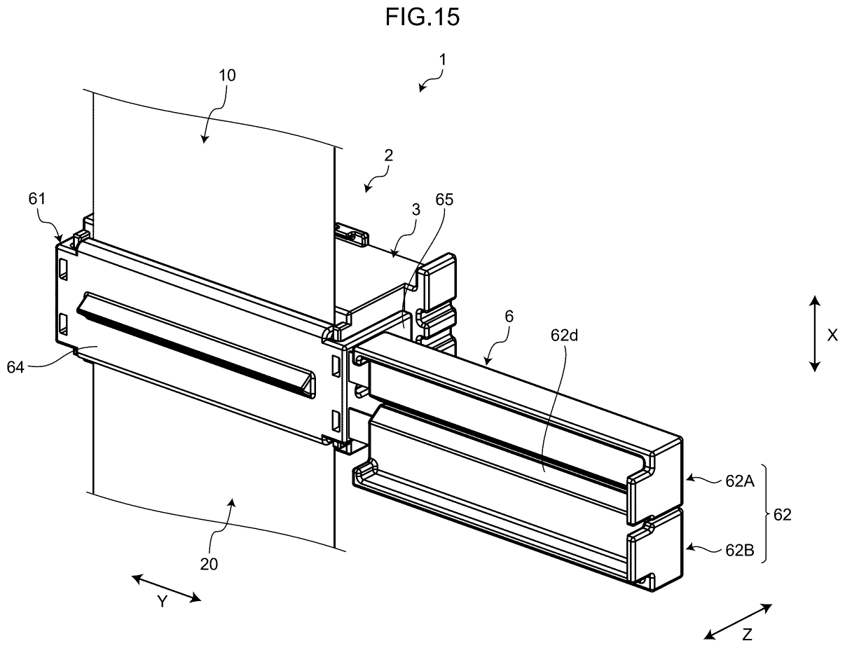

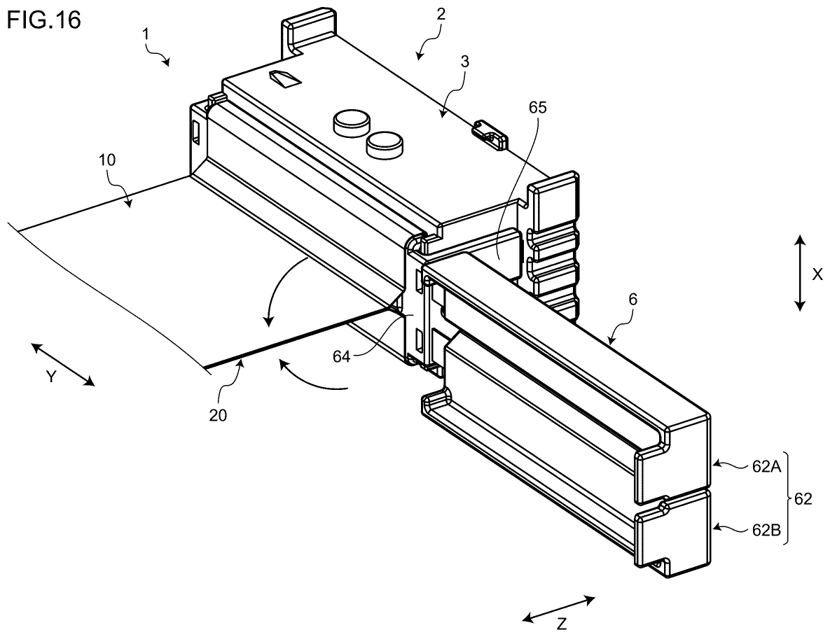

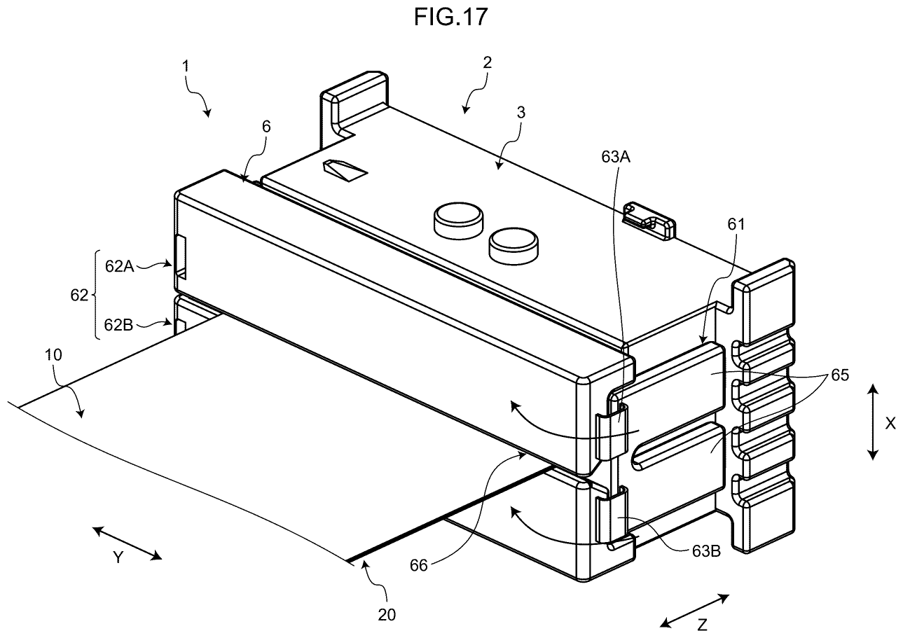

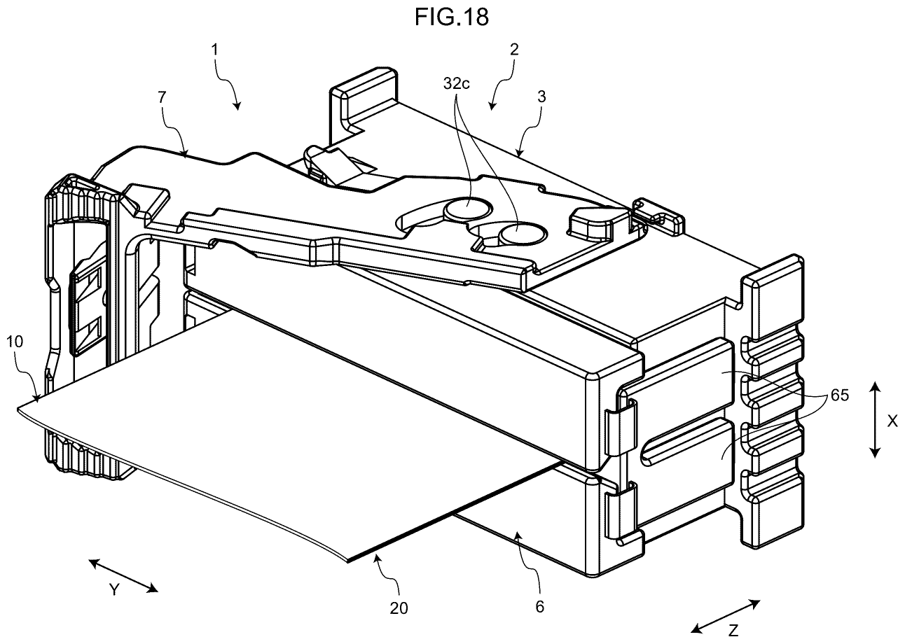

FIG. 11 is a diagram illustrating an operation of inserting the inner housing, FIG. 12 is a diagram illustrating an operation of inserting the terminal, FIG. 13 is a diagram illustrating an operation of installing the flexible printed wiring board, FIG. 14 is a plan view of the installed flexible printed wiring board, FIG. 15 is a diagram illustrating an operation of attaching the cover, FIG. 16 is a diagram illustrating an operation of bending the wiring board, FIG. 17 is a diagram illustrating an operation of retaining the wiring board, and FIG. 18 is a diagram illustrating an operation of assembling the lever.

As illustrated in FIG. 1, a wire harness 1 according to the present embodiment includes a connector 2 and flexible printed wiring boards 10 and 20. The wire harness 1 is mounted, for example, in a vehicle such as an automobile. The wire harness 1 can be connected to equipment disposed in an instrument panel. The connector 2 is configured to mate with a mating connector 100. The mating connector 100 is disposed on a housing of equipment such as a display or a meter device. The wire harness 1 can connect equipment having the mating connector 100 to a control device that controls the equipment. The flexible printed wiring boards 10 and 20 each have a printed circuit with a power line and a signal line.

The mating connector 100 includes a housing 110 and a plurality of terminals 120 retained by the housing 110. The connector 2 connects the printed circuit of the flexible printed wiring boards 10 and 20 to the terminal 120. The illustrated connector 2 is a lever-type connector with a lever 7. The connector 2 is capable of being mated with the housing 110 of the mating connector 100 using a force-multiplying mechanism that includes the lever 7.

As illustrated in FIG. 2, the connector 2 includes an outer housing 3, a plurality of inner housings 4, a plurality of terminals 5, the first flexible printed wiring board 10, the second flexible printed wiring board 20, and a cover 6. The outer housing 3 and the inner housing 4 are molded, for example, from an insulating synthetic resin. The illustrated outer housing 3 has a rectangular tubular shape and includes an accommodation portion 31 that accommodates the multiple inner housings 4.

The inner housing 4 is a member that retains the terminals 5 and is used to arrange the terminals 5. The inner housing 4 includes a cavity into which the terminals 5 are inserted. The multiple inner housings 4 are stacked and accommodated in the accommodation portion 31 of the outer housing 3.

In the following description, the direction in which the multiple inner housings 4 are stacked is referred to as a “first direction X”. Additionally, the direction in which the inner housings 4 are inserted into the outer housing 3 is referred to as a “third direction Z”. The third direction Z is orthogonal to the first direction X. In addition, the direction orthogonal to both the first direction X and the third direction Z is referred to as a “second direction Y”. The second direction Y corresponds to the alignment direction of the terminals 5 in each inner housing 4. In the present embodiment, each inner housing 4 retains the multiple terminals 5 aligned linearly in the second direction Y.

The flexible printed wiring boards 10 and 20 are film-like circuit bodies having flexibility. The first flexible printed wiring board 10 and the second flexible printed wiring board 20 are wiring boards independent of each other. The terminals 5 are inserted into through-holes of the flexible printed wiring boards 10 and 20 and are joined to the printed circuits of the flexible printed wiring boards 10 and 20.

The cover 6 is attached to the outer housing 3 while covering a joint between the flexible printed wiring boards 10 and 20 and the terminals 5. The cover 6 of the present embodiment is configured to retain the flexible printed wiring boards 10 and 20 in a state in which the two flexible printed wiring boards 10 and 20 are overlapped on each other, as will be described later.

As illustrated in FIG. 3, the outer housing 3 includes a tubular portion 32 and a bottom wall 33. The tubular portion 32 has a rectangular tubular shape and includes a pair of main walls 32a and a pair of side walls 32b. The pair of main walls 32a face each other in the first direction X and extend in the second direction Y. The main wall 32a has an outer surface on which a tubular shaft portion 32c is provided. The shaft portion 32c rotatably supports the lever 7.

The pair of side walls 32b face each other in the second direction Y and extend in the first direction X. A plurality of ribs 32d guiding the inner housing 4 is provided on the inner surface of the side wall 32b. The ribs 32d are protrusions that project in the second direction Y and extend linearly in the third direction Z.

The bottom wall 33 closes one end of the tubular portion 32. In other words, the outer housing 3 is a tubular member with a closed bottom. The tubular portion 32 and the bottom wall 33 form the accommodation portion 31. The bottom wall 33 is provided with a plurality of penetration-holes 33a. The terminals 120 of the mating connector 100 are inserted into the penetration-holes 33a and connected to the terminals 5. The multiple penetration-holes 33a is disposed in multiple rows. The penetration-holes 33a in each row are aligned in the second direction Y.

As illustrated in FIG. 4, the multiple inner housings 4 include a first-shaped housing 4A and a second-shaped housing 4B. The first-shaped housing 4A and the second-shaped housing 4B are rectangular flat plates. The first-shaped housing 4A includes a plurality of first cavities 45 to retain the terminals 5. The multiple first cavities 45 are aligned in the second direction Y and penetrate the first-shaped housing 4A along the third direction Z. The second-shaped housing 4B includes a plurality of second cavities 46 to retain the terminals 5. The second cavities 46 are aligned in the second direction Y and penetrate the second-shaped housing 4B along the third direction Z.

The first cavity 45 and the second cavity 46 are disposed with their positions shifted in the second direction Y. The second cavities 46 are positioned between two adjacent first cavities 45 in the second direction Y. Thus, the first cavities 45 and the second cavities 46 retain the multiple terminals 5 in a zigzag arrangement.

In the wire harness 1 of the present embodiment, the inclusion of the multiple stackable inner housings 4 allows adaptation to specification changes of the connector 2. For example, if different terminals 5 are used depending on the tab size of the terminals 120 of the mating connector 100, modifying the inner housing 4 enables adaptation to such specification changes.

The first-shaped housing 4A includes a first surface 41 and a second surface 42. The first surface 41 and the second surface 42 are two main surfaces of the first-shaped housing 4A and face in opposite directions. The second-shaped housing 4B includes a first surface 43 and a second surface 44. The first surface 43 and the second surface 44 are two main surfaces of the second-shaped housing 4B and face in opposite directions. The two housings 4A and 4B are stackable with the first surface 41 facing the second surface 44. Additionally, the two housings 4A and 4B are stackable with the first surface 43 facing the second surface 42. In other words, the first-shaped housing 4A and the second-shaped housing 4B are configured to be stackable by overlapping each other alternately.

The first-shaped housing 4A includes a first protrusion 41a and a first recess 42a. The first protrusion 41a is provided on the first surface 41. The first recess 42a is provided on the second surface 42. The second-shaped housing 4B includes a second protrusion 43a and a second recess 44a. The second protrusion 43a is provided on the first surface 43. The second recess 44a is provided on the second surface 44. The first protrusion 41a can be mated with the second recess 44a, and the second protrusion 43a can be mated with the first recess 42a. The first protrusion 41a is provided with an engagement portion 41b that engages with the second recess 44a. Similarly, the second protrusion 43a is provided with an engagement portion 43b that engages with the first recess 42a.

The first-shaped housing 4A is provided with a first support protrusion 47. The second-shaped housing 4B is provided with a second support protrusion 48. The support protrusions 47 and 48 are inserted into the flexible printed wiring boards 10 and 20 to minimize stress on the printed circuit and the joint. The first support protrusion 47 is disposed at one end in the second direction Y, and the second support protrusion 48 is disposed at the other end in the second direction Y.

As illustrated in FIG. 5, the terminal 5 includes a connection portion 51 and an insertion portion 52. The terminal 5 is formed from a conductive metal plate. The connection portion 51 is disposed at a first end portion 5a of the terminal 5, and the insertion portion 52 is disposed at a second end portion 5b of the terminal 5. The connection portion 51 is a portion that is connected to the terminal 120 of the mating connector 100. The illustrated connection portion 51 has a rectangular tubular shape into which the terminal 120 is inserted. The connection portion 51 is inserted and retained in the cavities 45 and 46 of the inner housing 4.

The insertion portion 52 is a portion that is inserted into a through-hole of each of the flexible printed wiring boards 10 and 20. The insertion portion 52 has a tubular shape. A tapered portion 52a with a gradually narrowing shape is provided at a distal end of the insertion portion 52. Moreover, the insertion portion 52 can be a solid rod without an internal space and can, for example, have a columnar shape.

As illustrated in FIG. 6, the first flexible printed wiring board 10 includes a base film 11, a printed circuit 12, and a coverlay 13. The base film 11 and the coverlay 13 are insulating films composed of a synthetic resin. The printed circuit 12 is a conductive metal foil formed on the base film 11. The coverlay 13 covers the pattern of the printed circuit 12 and is provided with openings 13a and 13b that expose lands 16b and 17b, respectively.

As illustrated in FIG. 7, the printed circuit 12 includes a first circuit group 14 and a second circuit group 15. The first circuit group 14 includes a plurality of circuits 16 extending in the first direction X. The multiple circuits 16 are arranged in the second direction Y. The second circuit group 15 includes a plurality of circuits 17 extending in the first direction X. The multiple circuits 17 are arranged in the second direction Y. The printed circuit 12 is configured such that one circuit 16 of the first circuit group 14 and one circuit 17 of the second circuit group 15 are alternately aligned.

The circuit 16 includes a pattern 16a and the land 16b provided at an end portion of the pattern 16a. The circuit 17 includes a pattern 17a and the land 17b provided at an end portion of the pattern 17a. The multiple lands 16b are aligned in a straight line along the second direction Y. The multiple lands 17b are aligned in a straight line along the second direction Y. In the first direction X, the position of the lands 17b is shifted with respect to the position of the lands 16b. More specifically, the lands 17b protrude toward an edge 11a of the base film 11 with respect to the lands 16b. Thus, the pattern 17a passes between two adjacent lands 16b.

The land 16b has a through-hole 16c formed therein into which the insertion portion 52 of the terminal 5 is inserted. The through-hole 16c extends through the base film 11. Similarly, the land 17b has a through-hole 17c formed therein. The through-hole 17c extends through the base film 11. The through-holes 16c and 17c are disposed in a sawtooth zigzag pattern on the first flexible printed wiring board 10. As illustrated in FIG. 6, the opening 13a of the coverlay 13 exposes the land 16b of the first circuit group 14. The opening 13b exposes the land 17b of the second circuit group 15.

The first flexible printed wiring board 10 is provided with two penetration-holes 10a and 10b. The two penetration-holes 10a and 10b are disposed at the end portion in the second direction Y with the printed circuit 12 positioned between these penetration-holes 10a and 10b. The penetration-hole 10a is aligned with the opening 13a and is disposed on an extension line in the second direction Y of the multiple lands 16b. The penetration-hole 10b is aligned with the opening 13b and is disposed on an extension line in the second direction Y of the multiple lands 17b. The support protrusion 47 of the first-shaped housing 4A is inserted into one of the two penetration-holes 10a and 10b. The support protrusion 48 of the second-shaped housing 4B is inserted into the other of the two penetration-holes 10a and 10b.

The second flexible printed wiring board 20 has a similar configuration to the first flexible printed wiring board 10. As illustrated in FIG. 8, the second flexible printed wiring board 20 includes a base film 21, a printed circuit 22, and a coverlay 23. The coverlay 23 covers the pattern of the printed circuit 22 and includes openings 23a and 23b, which expose the lands 26b and 27b, respectively.

As illustrated in FIG. 9, the printed circuit 22 includes a first circuit group 24 and a second circuit group 25. The first circuit group 24 includes a plurality of circuits 26 extending in a first direction X. The multiple circuits 26 are arranged in a second direction Y. The second circuit group 25 includes a plurality of circuits 27 extending in the first direction X. The multiple circuits 27 are arranged in the second direction Y. The printed circuit 22 is configured such that one circuit 26 of the first circuit group 24 and one circuit 27 of the second circuit group 25 are alternately aligned.

The circuit 26 has a pattern 26a and the land 26b provided at an end portion of the pattern 26a. The circuit 27 has a pattern 27a and the land 27b provided at an end portion of the pattern 27a. The multiple lands 26b and the multiple lands 27b are aligned in a straight line along the second direction Y. The land 27b protrudes closer to an edge 21a of the base film 21 compared to the land 26b. The pattern 27a passes between two adjacent lands 26b.

The land 26b has a through-hole 26c formed therein into which the insertion portion 52 of the terminal 5 is inserted. The land 27b has a through-hole 27c formed therein. In other words, the second flexible printed wiring board 20 has the through-holes 26c and 27c disposed in a sawtooth zigzag pattern. As illustrated in FIG. 8, the opening 23a of the coverlay 23 exposes the land 26b of the first circuit group 24. The opening 23b exposes the land 27b of the second circuit group 25.

The second flexible printed wiring board 20 is provided with two penetration-holes 20a and 20b. The two penetration-holes 20a and 20b are disposed at the end portions in the second direction Y with the printed circuit 22 positioned between these penetration-holes 20a and 20b. The penetration-hole 20a is aligned with the opening 23a and is disposed on an extension line in the second direction Y of the multiple lands 26b. The penetration-hole 20b is aligned with the opening 23b and is disposed on an extension line in the second direction Y of the multiple lands 27b. The support protrusion 47 of the first-shaped housing 4A is inserted into one of the two penetration-holes 20a and 20b. The support protrusion 48 of the second-shaped housing 4B is inserted into the other of the two penetration-holes 20a and 20b.

As illustrated in FIG. 2, the cover 6 includes a main body 61, a holding portion 62, and a hinge portion 63. The cover 6 is molded, for example, from an insulating synthetic resin. The main body 61 is a portion that covers a joint between the flexible printed wiring boards 10 and 20 and the terminals 5 and engages with the outer housing 3. The holding portion 62 is a portion that sandwiches and retains the flexible printed wiring boards 10 and 20 between the holding portion 62 and the main body 61. The hinge portion 63 connects the main body 61 and the holding portion 62 and has flexibility.

As illustrated in FIG. 10, the main body 61 includes a covering portion 64, which covers the joint, and four leg portions 65. The covering portion 64 is shaped like a rectangular flat plate. The leg portions 65 are disposed at both end portions of the covering portion 64 in the second direction Y. The leg portion 65 is a portion that engages with the outer housing 3 and protrudes from the covering portion 64 in the third direction Z. The leg portion 65 is provided with an engagement recess 65a and an engagement protrusion 65b. The engagement recess 65a is formed on the inner side of the leg portion 65 that faces the outer housing 3. The engagement recess 65a is provided on each of the four leg portions 65. As illustrated in FIG. 2, an engagement protrusion 34 is provided on the outer side of the outer housing 3. The engagement recess 65a of the cover 6 engages with the engagement protrusion 34.

The engagement protrusion 65b engages with the holding portion 62 to lock the holding portion 62. The engagement protrusion 65b is provided on two adjacent leg portions 65. The engagement protrusion 65b protrudes in the second direction Y from the outer surface, which is the surface opposite to the side where the engagement recess 65a is located.

The holding portion 62 includes a first holding portion 62A and a second holding portion 62B. The first holding portion 62A and the second holding portion 62B are aligned in the first direction X. The first holding portion 62A and the second holding portion 62B are rectangular in shape in a plan view. A slit 66 is provided between the first holding portion 62A and the second holding portion 62B. This configuration makes the first holding portion 62A and the second holding portion 62B independent of each other. The first holding portion 62A retains the first flexible printed wiring board 10. The second holding portion 62B retains the second flexible printed wiring board 20.

The hinge portion 63 is disposed at the end portion of the main body 61 opposite to the side where the engagement protrusion 65b is located. The hinge portion 63 includes a first hinge portion 63A and a second hinge portion 63B. The first hinge portion 63A connects the first holding portion 62A to the main body 61, while the second hinge portion 63B connects the second holding portion 62B to the main body 61. The end portions of each of the first holding portion 62A and the second holding portion 62B are provided with an engagement portion 62c that engages with the engagement protrusion 65b.

The covering portion 64 is provided with a rib 64a that restricts the folding profile of the flexible printed wiring boards 10 and 20. The rib 64a is disposed on a surface facing the holding portion 62 and extends in the second direction Y. The cross-sectional shape of the illustrated rib 64a is triangular. In other words, the cross-sectional shape of the rib 64a is tapered such that the width in the first direction X decreases toward the distal end in the protruding direction. The first holding portion 62A and the second holding portion 62B are provided with an inclined surface 62d corresponding to the rib 64a. The inclined surface 62d is disposed at the end portion adjacent to the slit 66. The rib 64a and the inclined surface 62d make the bending angle of the flexible printed wiring boards 10 and 20 an obtuse angle.

The following describes a method of manufacturing the wire harness 1 according to the present embodiment. The method of manufacturing the wire harness includes an operation of inserting the inner housing, an operation of inserting the terminal, an operation of installing the flexible printed wiring board, an operation of joining, an operation of attaching the cover, an operation of restricting the direction of the wiring board, and an operation of assembling the lever.

FIG. 11 illustrates the operation of inserting the inner housing. In this operation, the multiple stacked inner housings 4 are inserted into the outer housing 3. The first-shaped housings 4A and the second-shaped housings 4B are alternately stacked and inserted into the outer housing 3. The illustrated connector 2 includes two first-shaped housings 4A and two second-shaped housings 4B. The multiple inner housings 4 are inserted into the accommodation portion 31 along the third direction Z while being guided by the rib 32d. The multiple inner housings 4 are retained by the accommodation portion 31. The inner housings 4 can include an engagement portion that engages with the outer housing 3.

FIG. 12 illustrates the operation of inserting the terminal. The multiple terminals 5 are inserted into the cavity 45 of the first-shaped housing 4A and the cavity 46 of the second-shaped housing 4B. The connection portion 51 of the terminal 5 is inserted into the cavities 45 and 46. The inner housing 4 retains the connection portion 51 with the insertion portion 52 of the terminal 5 protruding from the cavities 45 and 46. This results in the formation of four rows of insertion portions 52 aligned in the second direction Y.

FIG. 13 illustrates the operation of installing the flexible printed wiring board. In this operation, the insertion portion 52 of the terminal 5 is inserted into the first flexible printed wiring board 10 and the second flexible printed wiring board 20. More specifically, two rows of insertion portions 52 are inserted into the first flexible printed wiring board 10, while the other two rows of insertion portions 52 are inserted into the second flexible printed wiring board 20.

The insertion portion 52 corresponding to the first flexible printed wiring board 10 is inserted into the land 16b of the first circuit group 14 and the land 17b of the second circuit group 15. The insertion portion 52 corresponding to the second flexible printed wiring board 20 is inserted into the land 26b of the first circuit group 24 and the land 27b of the second circuit group 25. Furthermore, the support protrusions 47 and 48 are inserted into the penetration-holes of the flexible printed wiring boards 10 and 20.

As illustrated in FIG. 14, the multiple terminals 5 include a first terminal group 5A and a second terminal group 5B. The first terminal group 5A is a group of the terminals 5 connected to the first flexible printed wiring board 10. The first terminal group 5A includes two rows of terminals 5 aligned in the second direction Y. The first terminal group 5A is constituted of terminals that are disposed on a first side X1 among the multiple terminals 5 of the connector 2. The second terminal group 5B is a group of the terminals 5 connected to the second flexible printed wiring board 20. The second terminal group 5B includes two rows of terminals 5 aligned in the second direction Y. The second terminal group 5B is constituted of terminals that are disposed on a second side X2 among the multiple terminals 5 of the connector 2.

The first flexible printed wiring board 10 includes the lands 16b and 17b connected to the insertion portions 52 of the first terminal group 5A. As illustrated in FIG. 7, the lands 16b and 17b include the through-holes 16c and 17c, respectively. The insertion portion 52 of the first terminal group 5A is inserted into the through-holes 16c and 17c. As illustrated in FIG. 14, one row of the insertion portions 52 of the first terminal group 5A is inserted into the land 16b, and the other row of the insertion portions 52 is inserted into the land 17b.

The second flexible printed wiring board 20 includes the lands 26b and 27b connected to the insertion portion 52 of the second terminal group 5B. As illustrated in FIG. 9, the lands 26b and 27b include the through-holes 26c and 27c, respectively. The insertion portion 52 of the second terminal group 5B is inserted into the through-holes 26c and 27c. As illustrated in FIG. 14, one row of the insertion portions 52 of the second terminal group 5B is inserted into the land 26b, and the other row of the insertion portions 52 is inserted into the land 27b.

The wire harness 1 of the present embodiment is capable of achieving both miniaturization of the connector 2 and multi-polarization of the terminal 5. As illustrated in FIG. 14, the insertion portion 52 of the terminal 5 is inserted into the lands 16b, 17b, 26b, and 27b and is joined to the lands 16b, 17b, 26b, and 27b. This allows the terminal 5 and the lands 16b, 17b, 26b, and 27b to be joined with a small joining area. As a result, it is possible for multiple rows of terminals 5 to be disposed with narrow intervals. For example, in the first terminal group 5A, it is possible to narrow the interval between the row of terminals 5 connected to the land 16b and the row of terminals 5 connected to the land 17b. Thus, in the wire harness 1 of the present embodiment, the connector 2 is capable of being made smaller at least in the first direction X.

The joining operation is the process of joining the insertion portion 52 of the terminals 5 to the lands 16b, 17b, 26b, and 27b. In the wire harness 1 of the present embodiment, the insertion portion 52 is soldered to the lands 16b, 17b, 26b, and 27b. Solder paste can be pre-applied to the lands 16b, 17b, 26b, and 27b. In this case, during the joining operation, soldering can be performed by irradiating the solder paste with laser light. For example, all the lands 16b, 17b, 26b, and 27b can be joined to the insertion portions 52 in a single irradiation. However, the soldering technique is not limited to the irradiation of laser light and can instead be performed using a reflow furnace or any other suitable technique.

The printed circuit 12 of the first flexible printed wiring board 10 extends from the first terminal group 5A toward the first side X1. The printed circuit 22 of the second flexible printed wiring board 20 extends from the second terminal group 5B toward the second side X2. In the wire harness 1 illustrated in FIG. 14, the first side X1 is one side in the first direction X, and the second side X2 is the other side in the first direction X. In other words, the two printed circuits 12 and 22 extend in opposite directions from each other.

In the operation of attaching the cover, as illustrated in FIG. 15, the main body 61 of the cover 6 is attached to the outer housing 3. The covering portion 64 of the main body 61 covers and protects the joint between the flexible printed wiring boards 10 and 20 and the terminals 5. In assembling the main body 61 to the outer housing 3, the holding portion 62 is positioned at a position shifted in the second direction Y relative to the flexible printed wiring boards 10 and 20.

The operation of restricting the direction of the wiring board includes an operation of folding the wiring board and an operation of retaining the wiring board. FIG. 16 is a diagram illustrated to describe the operation of folding the wiring board. In the operation of folding the wiring board, the first flexible printed wiring board 10 and the second flexible printed wiring board 20 are folded in such a way as to overlap each other. The two flexible printed wiring boards 10 and 20 are folded in a manner that wraps around the covering portion 64 and are overlapped with the coverlays 13 and 23 facing each other. In other words, the two flexible printed wiring boards 10 and 20 are folded into a U-shape at 1800 along the covering portion 64.

FIG. 17 is a diagram illustrated to describe the operation of retaining the wiring board. In the operation of retaining the wiring board, the two flexible printed wiring boards 10 and 20 are retained by the holding portion 62 of the cover 6. The cover 6 of the present embodiment retains the two flexible printed wiring boards 10 and 20 in an overlapping arrangement.

The first holding portion 62A engages with the main body 61 while bending the first hinge portion 63A. The first holding portion 62A sandwiches the first flexible printed wiring board 10 between the first holding portion 62A and the main body 61. The second holding portion 62B engages with the main body 61 while bending the second hinge portion 63B. The second holding portion 62B sandwiches the second flexible printed wiring board 20 between the second holding portion 62B and the main body 61. The two flexible printed wiring boards 10 and 20 are drawn out to the exterior through the slit 66 between the first holding portion 62A and the second holding portion 62B.

The cover 6 is configured to restrict the path and profile of the flexible printed wiring boards 10 and 20. The cover 6 of the present embodiment is configured to allow the two flexible printed wiring boards 10 and 20 to extend in the third direction Z through the slit 66. In this way, the cover 6 of the present embodiment not only has the function of protecting the joint between the flexible printed wiring boards 10 and 20 and the terminals 5, but also has the function of restricting the path of the flexible printed wiring boards 10 and 20. The two flexible printed wiring boards 10 and 20 are connected to equipment via a connector or the like. The two flexible printed wiring boards 10 and 20 can be connected to the same equipment or can be connected to different equipment.

FIG. 18 illustrates the connector 2 to which the lever 7 is attached. In the operation of assembling the lever, the lever 7 is attached to the outer housing 3. The connector 2 to which the lever 7 is attached is mated with the mating connector 100. The lever 7 amplifies the force applied to the lever 7 and transmits the force to the mating connector 100, causing the mating connector 100 to be mated to the outer housing 3.

As described above, the wire harness 1 of the present embodiment includes the connector 2, the first flexible printed wiring board 10, and the second flexible printed wiring board 20. The connector 2 includes the multiple terminals 5 and the housings 3 and 4. The terminal 5 has a rod-shaped or tubular insertion portion 52. The outer housing 3 and the inner housing 4 retain the multiple terminals 5 arranged in multiple rows with the insertion portion 52 protruding. The multiple arranged terminals 5 include the first terminal group 5A and the second terminal group 5B.

The first flexible printed wiring board 10 includes the through-holes 16c and 17c into which the insertion portion 52 of the first terminal group 5A is inserted and includes the printed circuit 12 connected to the insertion portion 52 of the first terminal group 5A. The second flexible printed wiring board 20 includes the through-holes 26c and 27c into which the insertion portion 52 of the second terminal group 5B is inserted and includes the printed circuit 22 connected to the insertion portion 52 of the second terminal group 5B. In the wire harness 1 of the present embodiment, the first terminal group 5A is inserted into the through-holes 16c and 17c and connected to the printed circuit 12, and the second terminal group 5B is inserted into the through-holes 26c and 27c and connected to the printed circuit 22. This connection configuration enables the connector 2 to be multi-polarized while suppressing an increase in the size of the connector 2. Additionally, in the wire harness 1 of the present embodiment, the visual inspection of the joint using automated optical inspection (AOI) can be performed with ease.

In the wire harness 1 of the present embodiment, the printed circuit 12 of the first flexible printed wiring board 10 extends from the first terminal group 5A toward the first side. The printed circuit 22 of the second flexible printed wiring board 20 extends from the second terminal group 5B toward the second side. The second side is different from the first side. In the wire harness 1 illustrated in FIG. 14, the second side X2 is opposite to the first side X1. In this case, it is easy to join the two flexible printed wiring boards 10 and 20 to the terminals 5 in a single joining operation. However, the second side is not limited to the opposite side as long as the second side is different from the first side.

In the present embodiment, the terminals 5 of the second terminal group 5B are disposed on the second side X2 with respect to the terminals 5 of the first terminal group 5A, as illustrated in FIG. 14. In other words, a boundary line in the second direction Y is provided between the first terminal group 5A and the second terminal group 5B. Such an arrangement of the terminals 5 makes it easy to connect the two flexible printed wiring boards 10 and 20 to the connector 2.

Moreover, the number of the inner housings 4 included in the connector 2 is not limited to four. For example, the first cavity 45 and the second cavity 46 can be provided in the first-shaped housing 4A, and the first cavity 45 and the second cavity 46 can be provided in the second-shaped housing 4B. In this case, the number of the inner housings 4 included in the connector 2 can be two.

The housing of the connector 2 is not necessarily divided into the outer housing 3 and the inner housing 4. For example, the outer housing 3 can be provided with the cavities 45 and 46.

The connector 2 is not limited to a lever-type connector with the lever 7. The cover 6 is not limited to having the holding portion 62. For example, if the two flexible printed wiring boards 10 and 20 are routed in different directions from the connector 2, the path regulation by the holding portion 62 can be omitted.

Additionally, if the protection of the joint is made by a separate member, the connector 2 is configurable without the cover 6.

### Modification of Embodiment

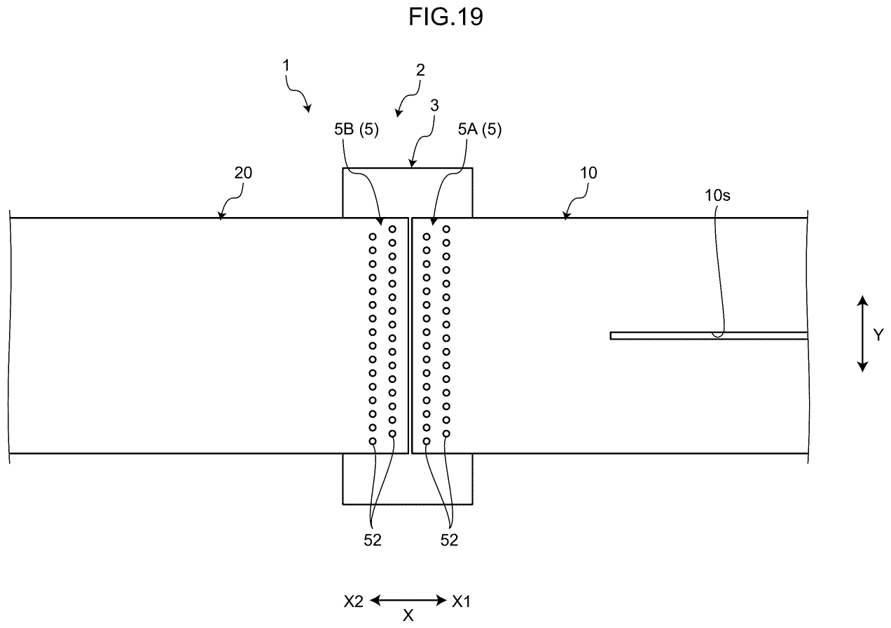

A modification of the embodiment is now described with reference to FIGS. 19 to 23. FIGS. 19 to 23 are diagrams of a wire harness according to a modification of the embodiment.

A first flexible printed wiring board 10 and a second flexible printed wiring board 20 can each include a branch at a location along their respective lengths. In a wire harness 1 illustrated in FIG. 19, the first flexible printed wiring board 10 branches. More specifically, the first flexible printed wiring board 10 branches into two by a slit 10s. Thus, the first flexible printed wiring board 10 is capable of connecting a terminal 5 of a first terminal group 5A to two pieces of different equipment. The flexible printed wiring boards 10 and 20 can have three or more branches.

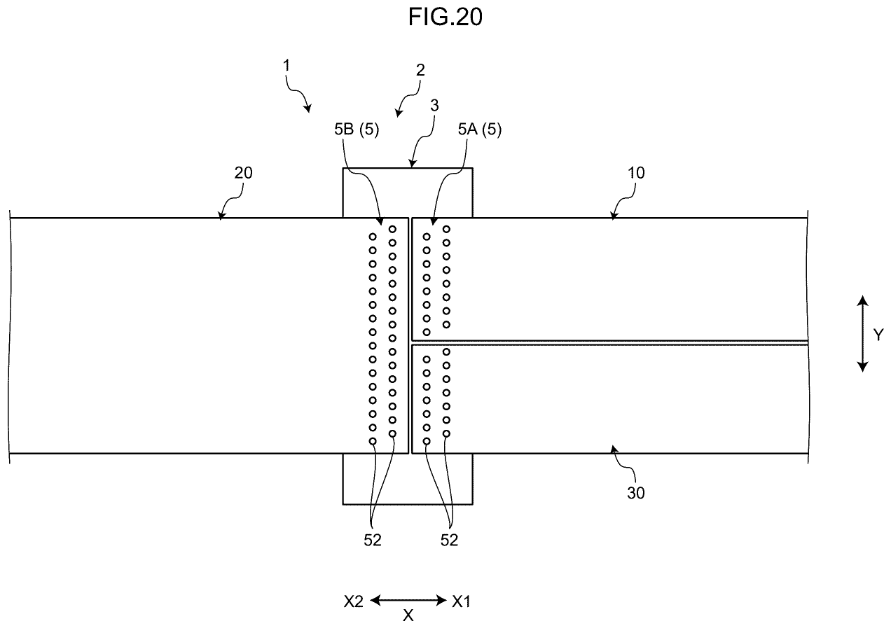

The wire harness 1 can include three or more flexible printed wiring boards. The wire harness 1 illustrated in FIG. 20 includes, in addition to the flexible printed wiring boards 10 and 20, a third flexible printed wiring board 30. The first flexible printed wiring board 10 and the third flexible printed wiring board 30 are connected to the terminal 5 of the first terminal group 5A. The second flexible printed wiring board 20 is connected to a terminal 5 of a second terminal group 5B, which is similar to the embodiment previously mentioned. Moreover, three or more flexible printed wiring boards can be connected to the first terminal group 5A. A plurality of flexible printed wiring boards can be connected to the second terminal group 5B.

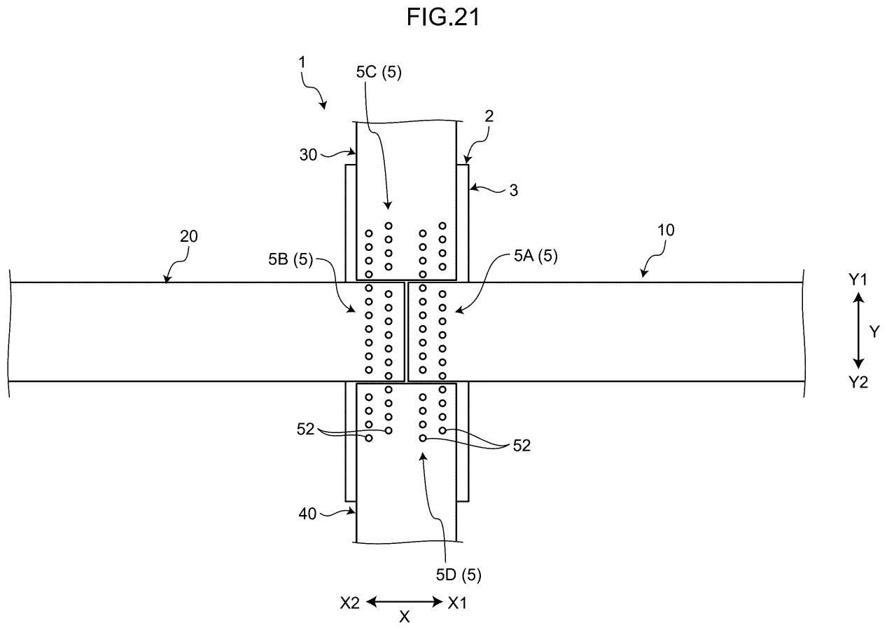

The flexible printed wiring boards can be connected to the terminal 5 so as to extend in a direction different from the first direction X. The wire harness 1 illustrated in FIG. 21 includes flexible printed wiring boards 30 and 40 extending in the second direction Y. In addition to the first terminal group 5A and the second terminal group 5B, the multiple terminals 5 include a third terminal group 5C and a fourth terminal group 5D. The third terminal group 5C is disposed on one side Y1 of the second direction Y with respect to the first terminal group 5A and the second terminal group 5B. The fourth terminal group 5D is disposed on the other side Y2 of the second direction Y with respect to the first terminal group 5A and the second terminal group 5B.

The third flexible printed wiring board 30 is connected to the third terminal group 5C. The third flexible printed wiring board 30 extends from the third terminal group 5C toward the one side Y1. The fourth flexible printed wiring board 40 is connected to the fourth terminal group 5D. The fourth flexible printed wiring board 40 extends from the fourth terminal group 5D toward the other side Y2.

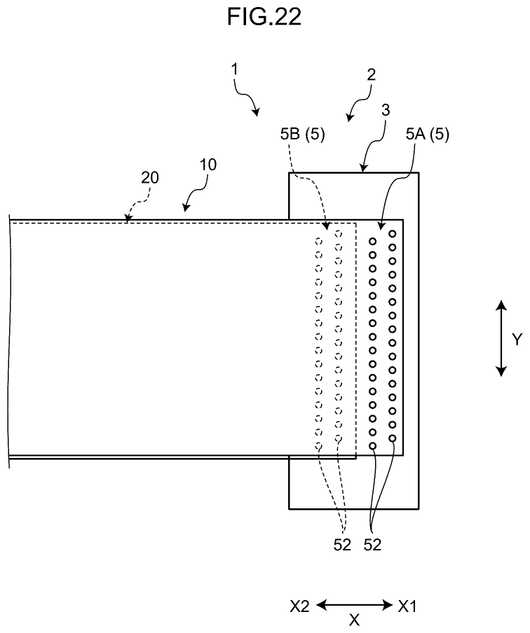

The two flexible printed wiring boards 10 and 20 can be connected to the terminal 5 in such a way as to extend from the terminal groups 5A and 5B toward the same side. In the wire harness 1 illustrated in FIG. 22, the first flexible printed wiring board 10 is connected to the first terminal group 5A in such a way as to extend from the first terminal group 5A toward the second side X2. Thus, the two flexible printed wiring boards 10 and 20 extend from the terminal 5 toward the second side X2 while overlapping each other.

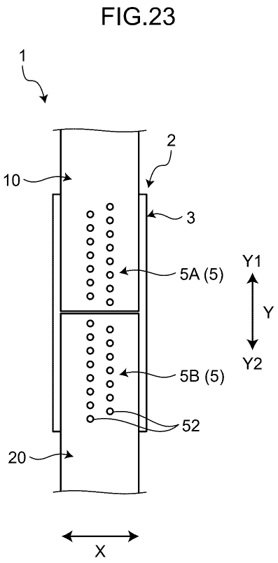

The extending direction of the flexible printed wiring boards 10 and 20 is not limited to the first direction X. In the wire harness 1 illustrated in FIG. 23, the flexible printed wiring boards 10 and 20 extend from the terminal 5 toward the second direction Y. In this case, the first terminal group 5A is a group of terminals 5 located on one side Y1 of the second direction Y among the multiple terminals 5. The second terminal group 5B is a group of terminals 5 located on the other side Y2 of the second direction Y with respect to the first terminal group 5A.

The first flexible printed wiring board 10 extends from the first terminal group 5A toward one side Y1 of the second direction Y. The second flexible printed wiring board 20 extends from the second terminal group 5B toward the other side Y2 of the second direction Y.

The disclosures set forth in the previously mentioned embodiments and modifications can be implemented in appropriate combinations.

According to the present embodiment, the wire harness includes the connector, the first flexible printed wiring board, and the second flexible printed wiring board, in this configuration, the connector has the multiple arranged terminals that include the first terminal group and the second terminal group, the first flexible printed wiring board includes the through-hole into which the insertion portion of the first terminal group is inserted and the printed circuit connected to the insertion portion of the first terminal group, and the second flexible printed wiring board includes the through-hole into which the insertion portion of the second terminal group is inserted and the printed circuit connected to the insertion portion of the second terminal group. According to the present embodiment, the wire harness enables the achievement of both multi-polarization of the connector and the suppression of size enlargement of the connector.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a connector that includes a plurality of terminals and a housing, each of the terminals having a rod-shaped or tubular insertion portion, the housing retaining the terminals arranged in a plurality of rows with the insertion portion protruding, the arranged terminals including a first terminal group and a second terminal group;
a first flexible printed wiring board provided with a through-hole into which the insertion portion of the first terminal group is inserted and a printed circuit connected to the insertion portion of the first terminal group; and
a second flexible printed wiring board provided with a through-hole into which the insertion portion of the second terminal group is inserted and a printed circuit connected to the insertion portion of the second terminal group, wherein
the first terminal group includes two rows of terminals,
the printed circuit of the first flexible printed wiring board is connected to the rows of terminals of the first terminal group,
the second terminal group includes two rows of terminals, and
the printed circuit of the second flexible printed wiring board is connected to the rows of terminals of the second terminal group.

2. The wire harness according to claim 1, wherein
the printed circuit of the first flexible printed wiring board extends from the first terminal group toward a first side, and
the printed circuit of the second flexible printed wiring board extends from the second terminal group toward a second side different from the first side.

3. The wire harness according to claim 2, wherein
the second side is opposite to the first side.

4. The wire harness according to claim 3, wherein
the terminals of the second terminal group are disposed on the second side with respect to the terminals of the first terminal group.
